(19) United States
(12) Patent Application Publication
(10) Pub. No.: US 2025/0313115 A1
(43) Pub. Date: Oct. 9, 2025

(54) CHARGE-DISCHARGE SYSTEM AND METHOD FOR CONTROLLING CHARGE-DISCHARGE SYSTEM

(71) Applicant: GS Yuasa International Ltd., Kyoto-shi, Kyoto (JP)

(72) Inventors: Shun KAKIUCHI, Kyoto-shi, Kyoto (JP); Akira KAMATA, Kyoto-shi, Kyoto (JP); Kentaro HAYASHI, Kyoto-shi, Kyoto (JP)

(21) Appl. No.: 18/708,992

(22) PCT Filed: Nov. 7, 2022
(86) PCT No.: PCT/JP2022/041316

§ 371 Date: Oct. 31, 2024

(30) Foreign Application Priority Data
Nov. 11, 2021 (JP) 2021-184207

(51) Int. Cl. B60L 53/67; B60L 53/62; B60L 53/63; B60L 53/66; B60L 53/68; B60L 55/00

(52) U.S. Cl. CPC B60L 53/67; B60L 53/62; B60L 53/63; B60L 53/66; B60L 53/68; B60L 55/00; B60L 2210/14; B60L 2210/30; B60L 2210/40

(57) ABSTRACT

A charge-discharge system 10 includes: an acquisition unit 161 that acquires system power information 164a indicating power flowing between a power system 60 and the charge-discharge system 10 and vehicle power information 164b indicating power charged and discharged between a vehicle energy storage apparatus 51 and the charge-discharge system 10; a generation unit 162 that generates display data 164l for causing a display device 41 to display a screen including area information 164e indicating a supply area 1, system information 164f indicating the power system 60, vehicle energy storage apparatus information 164g indicating the vehicle energy storage apparatus 51, a system current direction diagram 164i indicating a direction of a current of power indicated by the system power information 164a, a vehicle current direction diagram 164j indicating a direction of a current of power indicated by the vehicle power information 164b, and load information 164d indicating a power consumption state of a power load 20; and a transmission unit 163 that transmits the display data 164l to the display device 41.

### TECHNICAL FIELD

The present invention relates to a charge-discharge system that performs charge-discharge with a vehicle energy storage apparatus that is an energy storage apparatus included in a vehicle, and a method of controlling the charge-discharge system.

### BACKGROUND ART

Patent Document 1 discloses a grid interconnection system (charge-discharge system) that is supplied with electric power from a power system, performs charge-discharge with a battery (vehicle energy storage apparatus) mounted on an electric vehicle, and supplies electric power to a power load.

### PRIOR ART DOCUMENT

### Patent Document

Patent Document 1: JP-A-2020-10442

### SUMMARY OF THE INVENTION

### Problems to be Solved by the Invention

In conventional charge-discharge systems as disclosed in Patent Document 1, since power is exchanged between the power system, the vehicle energy storage apparatus, and the power load, it may be difficult to grasp the exchange of the power. For this reason, it is desirable to enable easily grasping the exchange of power in the charge-discharge system.

An object of the present invention is to provide a charge-discharge system that enables easily grasping exchange of power, and a method for controlling the charge-discharge system.

### Means for Solving the Problems

A charge-discharge system according to one aspect of the present invention performs charge-discharge with a vehicle energy storage apparatus that is an energy storage apparatus included in a vehicle in a predetermined supply area to which power from a power system is supplied, and supplies power to a power load in the supply area, the charge-discharge system including: an acquisition unit that acquires system power information indicating power flowing between the power system and the charge-discharge system and vehicle power information indicating power charged and discharged between the vehicle energy storage apparatus and the charge-discharge system; a generation unit that generates display data for causing a display device to display a screen including area information indicating the supply area, system information indicating the power system, vehicle energy storage apparatus information indicating the vehicle energy storage apparatus, a system current direction diagram that is a diagram indicating a direction of a current of power indicated by the system power information, a vehicle current direction diagram that is a diagram indicating a direction of a current of power indicated by the vehicle power information, and load information indicating a power consumption state of the power load; and a transmission unit that transmits the display data to the display device.

The present invention can be realized not only as such a charge-discharge system but also as a method for controlling a charge-discharge system. The present invention can also be realized as a program for causing a computer to execute processing included in a method for controlling a charge-discharge system, and can also be realized as a recording medium such as a computer-readable CD-ROM in which the program is recorded. The program can be distributed via the recording medium and a transmission medium such as the Internet. The present invention can also be realized as an integrated circuit including a processing unit included in a charge-discharge system.

### Advantages of the Invention

According to the charge-discharge system and the like of the present invention, the exchange of power can be easily grasped.

### BRIEF DESCRIPTION OF THE DRAWINGS

FIG. 1 is a diagram illustrating an outline of a remote monitoring system including a charge-discharge system according to an embodiment.

FIG. 2 is a perspective view illustrating a configuration of the charge-discharge system according to the embodiment.

FIG. 3 is a block diagram illustrating a functional configuration of the charge-discharge system according to the embodiment.

FIG. 4 is a block diagram illustrating a functional configuration of a first communication unit according to the embodiment.

FIG. 5 is a diagram illustrating an example of display data displayed on a display device according to the embodiment.

FIG. 6 is a flowchart showing processing (a method for controlling the charge-discharge system) performed by the charge-discharge system according to the embodiment.

FIG. 7 is a flowchart illustrating processing in which a generation unit of a first communication unit according to the embodiment generates display data.

FIG. 8 is a flowchart illustrating power presence/absence determination processing performed by the generation unit according to the embodiment.

FIG. 9 is a diagram illustrating an example of display data generated by the generation unit according to the embodiment performing power presence/absence determination processing.

FIG. 10 is a flowchart illustrating connection presence/absence determination processing performed by the generation unit according to the embodiment.

FIG. 11 is a diagram illustrating an example of display data generated by the generation unit according to the embodiment performing the connection presence/absence determination processing.

FIG. 12 is a flowchart illustrating selection information acquisition processing performed by the generation unit according to the embodiment.

FIG. 13 is a diagram illustrating an example of display data generated by the generation unit according to the embodiment performing selection information acquisition processing.

FIG. 14A is a diagram illustrating an example of display data displayed on a display device according to Modification 1 of the embodiment.

FIG. 14B is a diagram illustrating an example of display data displayed on the display device according to Modification 1 of the embodiment.

FIG. 15 is a diagram illustrating an example of display data displayed on a display device according to Modification 2 of the embodiment.

### MODE FOR CARRYING OUT THE INVENTION

A charge-discharge system according to one aspect of the present invention is a charge-discharge system that performs charge-discharge with a vehicle energy storage apparatus that is an energy storage apparatus included in a vehicle in a predetermined supply area to which power from a power system is supplied, and supplies power to a power load in the supply area, the charge-discharge system including: an acquisition unit that acquires system power information indicating power flowing between the power system and the charge-discharge system and vehicle power information indicating power charged and discharged between the vehicle energy storage apparatus and the charge-discharge system; a generation unit that generates display data for causing a display device to display a screen including area information indicating the supply area, system information indicating the power system, vehicle energy storage apparatus information indicating the vehicle energy storage apparatus, a system current direction diagram that is a diagram indicating a direction of a current of power indicated by the system power information, a vehicle current direction diagram that is a diagram indicating a direction of a current of power indicated by the vehicle power information, and load information indicating a power consumption state of the power load; and a transmission unit that transmits the display data to the display device.

According to this, the charge-discharge system generates display data for causing the display device to display a screen including the area information, the system information, the vehicle energy storage apparatus information, the system current direction diagram, the vehicle current direction diagram, and the load information, and transmits the display data to the display device. That is, the charge-discharge system transmits, to the display device, display data of a screen including information indicating the supply area, the power system, the vehicle energy storage apparatus, and the power load, and a diagram indicating a direction of a current of power between the power system and the vehicle energy storage apparatus. It is easy to intuitively grasp the exchange (purchase or sale) of power between the charge-discharge system and the power system by a diagram (system current direction diagram) indicating the direction of current of power between the charge-discharge system and the power system. It is easy to intuitively grasp the exchange (charge or discharge) of power between the charge-discharge system and the vehicle energy storage apparatus by a diagram (vehicle current direction diagram) indicating the direction of current of power between the charge-discharge system and the vehicle energy storage apparatus. Therefore, since the exchange of power between the charge-discharge system and the power system and the vehicle energy storage apparatus in a target supply area can be displayed in a diagram on the screen of the display device, the exchange of power in the charge-discharge system can be easily grasped.

The generation unit may determine at least one of whether or not power indicated by the system power information is zero and whether or not power indicated by the vehicle power information is zero, generate, when determining that power indicated by the system power information is zero, the display data for causing the display device to display a screen including the system current direction diagram different from a case where the power is not zero, or a screen not including the system current direction diagram, and generate, when determining that power indicated by the vehicle power information is zero, the display data for causing the display device to display a screen including the vehicle current direction diagram different from a case where the power is not zero, or a screen not including the vehicle current direction diagram.

According to this, the charge-discharge system generates, when determining that the power of at least one of the system power information and the vehicle power information is zero, display data for causing the display device to display a screen including a diagram different from a case where the power is not zero or a screen not including a diagram. That is, the charge-discharge system generates, when power is not exchanged with at least one of the power system and the vehicle energy storage apparatus, display data for causing the display device to display a screen indicating that power is not exchanged. If it is found that power is not exchanged between the charge-discharge system and the power system, it can be grasped that the supply of power from the power system to the charge-discharge system is stopped due to a power failure or the like. If it is known that no power is exchanged between the charge-discharge system and the vehicle energy storage apparatus, it can be grasped that charge-discharge is stopped between the charge-discharge system and the vehicle energy storage apparatus due to full charge of the vehicle energy storage apparatus, failure of equipment, or the like. Therefore, it is possible to cause the display device to display a screen on which it can be intuitively grasped that the supply of power from the power system to the charge-discharge system is stopped or the charge-discharge is stopped between the charge-discharge system and the vehicle energy storage apparatus. This makes it possible to easily grasp the exchange of power in the charge-discharge system.

The generation unit may generate the display data for causing the display device to display a screen on which the system information and the system current direction diagram are located above the area information and the vehicle energy storage apparatus information, the vehicle current direction diagram, and the load information are located below the area information.

According to this, the charge-discharge system generates display data for causing the display device to display a screen on which the information and the diagram on the power system are located above the area information and the information and the diagram on the vehicle energy storage apparatus and the power load are located below the area information. As a result, it is possible to divide the information and diagram of the power system (system information and system current direction diagram) and the information and diagram of the vehicle energy storage apparatus and the power load (vehicle energy storage apparatus information, the vehicle current direction diagram, and the load information) and display them at intuitively understandable positions on the screen of the display device. Therefore, exchange of power in the charge-discharge system can be easily grasped.

The generation unit may generate, when determining whether or not the vehicle energy storage apparatus is connected to the charge-discharge system and determining that the vehicle energy storage apparatus is not connected to the charge-discharge system, the display data for causing the display device to display a screen including the vehicle energy storage apparatus information different from a case where the generation unit determines that the vehicle energy storage apparatus is connected to the charge-discharge system, or a screen not including the vehicle energy storage apparatus information.

According to this, the charge-discharge system generates, when determining that the vehicle energy storage apparatus is not connected to the charge-discharge system, display data of a screen including vehicle energy storage apparatus information different from a case where the charge-discharge system determines that the vehicle energy storage apparatus is connected, or a screen not including the information. That is, the charge-discharge system generates, when the vehicle energy storage apparatus is not connected to the charge-discharge system, display data for causing the display device to display a screen indicating that the vehicle energy storage apparatus is not connected. As a result, since the connection state of the vehicle energy storage apparatus to the charge-discharge system can be displayed on the screen of the display device, it is easy to intuitively grasp that even if the charge-discharge is stopped between the charge-discharge system and the vehicle energy storage apparatus, it is not a failure of the equipment, and the like. Therefore, exchange of power in the charge discharge system can be easily grasped.

Plural vehicle energy storage apparatuses may be connected to the charge-discharge system, the acquisition unit may be configured to be able to acquire vehicle selection information indicating that the vehicle energy storage apparatus information or the vehicle current direction diagram displayed on the display device has been selected, and the generation unit may generate, when the acquisition unit has not acquired the vehicle selection information, the display data for causing the display device to display a screen including the vehicle energy storage apparatus information and the vehicle current direction diagram by regarding the plurality of vehicle energy storage apparatuses as one vehicle energy storage apparatus, and may generate, when the acquisition unit has acquired the vehicle selection information, the display data for causing the display device to display a screen including the vehicle energy storage apparatus information and the vehicle current direction diagram for each of the vehicle energy storage apparatuses.

According to this, the charge-discharge system generates, when acquiring the vehicle selection information, display data of a screen including the vehicle energy storage apparatus information and the vehicle current direction diagram for each of the vehicle energy storage apparatuses. As a result, when plural vehicle energy storage apparatuses are connected to the charge-discharge system, the information and diagram for each of the vehicle energy storage apparatuses can be displayed on the screen of the display device, so that it is easy to intuitively grasp the states of the plural vehicle energy storage apparatuses. Therefore, even when plural vehicle energy storage apparatuses are connected to the charge-discharge system, the exchange of power in the charge-discharge system can be easily grasped for each of the vehicle energy storage apparatuses.

At least one of a power generation apparatus and an energy storage apparatus may be connected to the charge-discharge system, the acquisition unit may acquire apparatus power information indicating power flowing between at least one of the power generation apparatus and the energy storage apparatus and the charge-discharge system, and the generation unit may generate the display data for causing the display device to display a screen further including apparatus information indicating at least one of the power generation apparatus and the energy storage apparatus and an apparatus current direction diagram which is a diagram indicating a direction of a current of power indicated by the apparatus power information.

According to this, the charge-discharge system generates display data for causing the display device to display a screen further including the apparatus information and the apparatus current direction diagram. That is, the charge-discharge system generates display data of a screen further including information indicating at least one of the power generation apparatus and the energy storage apparatus and a diagram indicating a direction of a current of power flowing between the at least one and the charge-discharge system. As a result, even when at least one of the power generation apparatus and the energy storage apparatus is connected to the charge-discharge system, the exchange of power between the charge-discharge system and at least one of the power generation apparatus and the energy storage apparatus can be displayed in a diagram on the screen of the display device. Therefore, since it is easy to intuitively grasp the exchange of power between the charge-discharge system and at least one of the power generation apparatus and the energy storage apparatus, the exchange of power in the charge-discharge system can be easily grasped.

Plural power generation apparatuses or plural energy storage apparatuses may be connected to the charge-discharge system, the acquisition unit may be configured to be able to acquire apparatus selection information indicating that the apparatus information or the apparatus current direction diagram displayed on the display device has been selected, and the generation unit may generate, when the acquisition unit has not acquired the apparatus selection information, the display data for causing the display device to display a screen including the apparatus information and the apparatus current direction diagram by regarding the plurality of power generation apparatuses or the plurality of energy storage apparatuses as one power generation apparatus or one energy storage apparatus, and may generate, when the acquisition unit has acquired the apparatus selection information, the display data for causing the display device to display a screen including the apparatus information and the apparatus current direction diagram for each of the power generation apparatuses or the energy storage apparatuses.

According to this, the charge-discharge system may generate, when acquiring the apparatus selection information, display data of a screen including the apparatus information and the apparatus current direction diagram for each of the power generation apparatuses or the energy storage apparatuses. As a result, when plural power generation apparatuses or plural energy storage apparatuses are connected to the charge-discharge system, the information and diagram for each of the power generation apparatuses or the energy storage apparatuses can be displayed on the screen of the display device. Therefore, even when plural power generation apparatuses or plural energy storage apparatuses are connected to the charge-discharge system, since it is easy to intuitively grasp the states of the plural power generation apparatuses or the plural energy storage apparatuses, the exchange of power in the charge-discharge system can be easily grasped.

Hereinafter, a charge-discharge system, a method for controlling the charge-discharge system, and the like according to an embodiment of the present invention (including a modification example thereof) will be described with reference to the drawings. The embodiments described below show comprehensive or specific examples. Numerical values, components, arrangement positions and connection forms of the components, control processing, an order of the control processing, and the like described in the following embodiments are merely examples, and are not intended to limit the present invention. Each drawing is a schematic view and is not necessarily an exact illustration. In the drawings, the same or similar components are denoted by the same reference numerals.

### EMBODIMENT

### [1 Description of Charge-Discharge System 10]

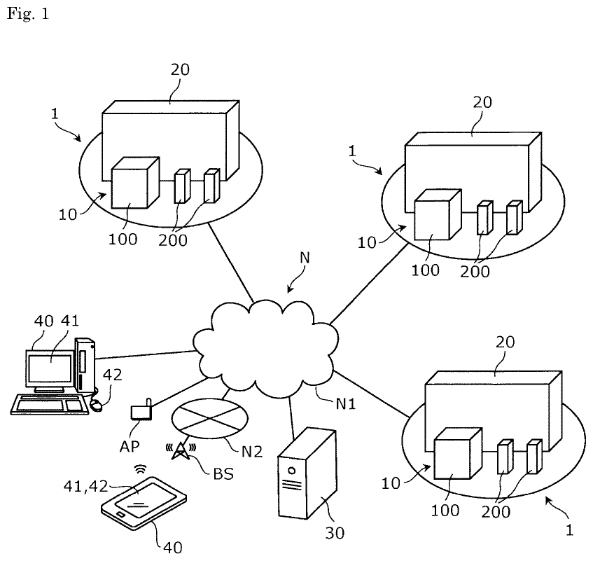

First, the charge-discharge system 10 will be generally described. FIG. 1 is a diagram illustrating an outline of a remote monitoring system including charge-discharge system 10 according to the present embodiment.

As illustrated in FIG. 1, plural (three in FIG. 1) supply areas 1, a server device 30 capable of collecting information on the supply area 1, a client device 40 capable of browsing the information on the supply area 1, and a network N which is a communication medium are arranged in the remote monitoring system. As a result, the information on the supply area 1 is displayed on a display device 41 of the client device 40 via the network N (and the server device 30), so that remote monitoring can be performed.

The supply area 1 is a predetermined site to which power from a power system is supplied, and is partitioned by a predetermined region such as a consumer unit, a facility unit, or a building unit. In each of the supply areas 1, a charge-discharge system 10 including a power conditioner 100 and a charge-discharge device 200 and a power load 20 are disposed, and power is supplied from the charge-discharge system 10 to the power load 20. The power load 20 is a power load consumed by power consumption equipment in a building (office or the like) disposed in each of the supply areas 1, power consumption equipment installed outdoors, or the like.

The server device 30 includes a web server function, and presents information obtained from the charge-discharge system 10 in the supply area 1 according to access from the client device 40. The server device 30 may be realized by a general-purpose computer system such as a personal computer executing a program, or may be realized by a dedicated computer system.

The network N includes a public communication network N1 which is so-called the Internet and a carrier network N2 which realizes wireless communication according to a predetermined mobile communication standard. The public communication network N1 includes a general optical line, and the network N includes a dedicated line connected to the server device 30. The carrier network N2 includes a base station BS, and the client device 40 can communicate with the server device 30 from the base station BS via the network N. An access point AP is connected to the public communication network N1, and the client device 40 can communicate with the server device 30 from the access point AP via the network N.

The client device 40 may be a desktop type or laptop type personal computer, or may be a so-called smartphone or tablet type communication terminal. The client device 40 includes a display device 41 such as a liquid crystal display, an input device 42 such as a keyboard, a mouse, or a touch panel, a control device, a storage unit (memory), a communication device, and the like. The storage unit stores a client program including a web browser and the like, the client program being read and executed by the control device. The user who has logged in through a login screen displayed on the web browser of the client device 40 can access information regarding a system in which the user is involved, the information being provided from the server device 30.

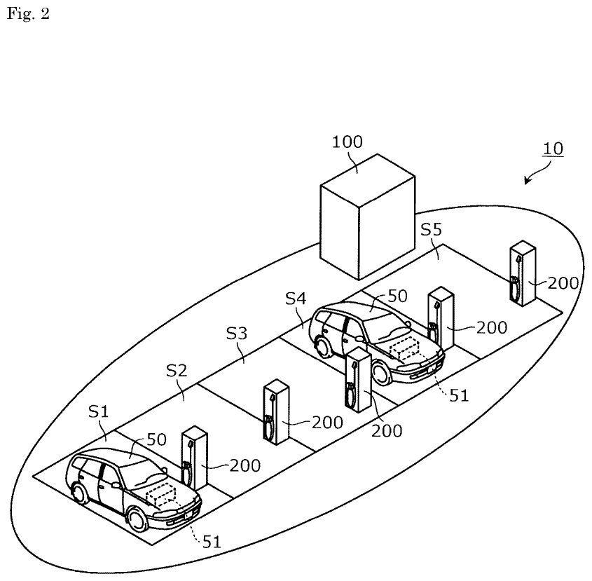

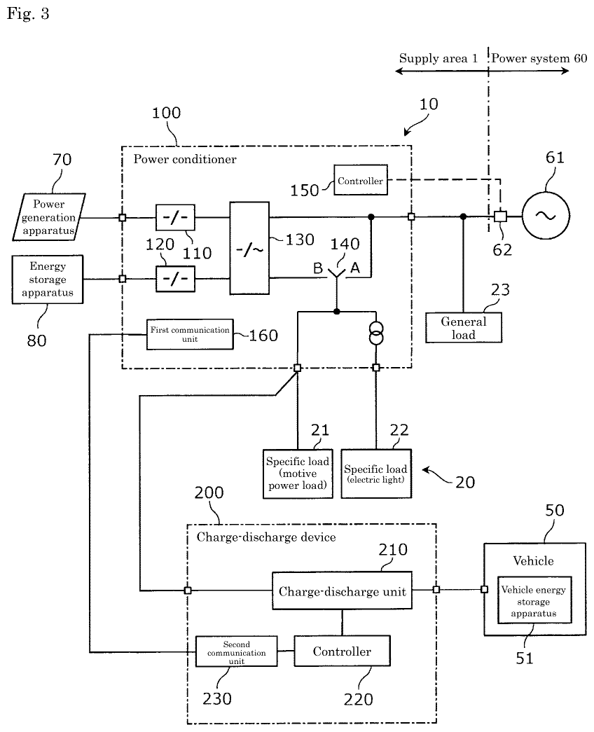

Next, the charge-discharge system 10 will be described in detail. FIG. 2 is a perspective view illustrating a configuration of the charge-discharge system 10 according to the present embodiment. Specifically, FIG. 2 is an image diagram illustrating a configuration of the power conditioner 100 and the charge-discharge device 200 included in the charge-discharge system 10, and a state in which a vehicle energy storage apparatus 51 of a vehicle 50 is connected to the charge-discharge device 200. FIG. 3 is a block diagram illustrating a functional configuration of the charge-discharge system 10 according to the present embodiment. Specifically, FIG. 3 illustrates a configuration in which the charge-discharge system 10 is connected to the vehicle energy storage apparatus 51 of the vehicle 50, the power system 60, the power generation apparatus 70, the energy storage apparatus 80, and the power load 20 in the supply area 1.

The charge-discharge system 10 is a system that performs charge-discharge with vehicle energy storage apparatus 51, which is an energy storage apparatus included in the vehicle 50, in the predetermined supply area 1 to which power from the power system 60 is supplied, and supplies power to the power load 20 in the supply area 1. As illustrated in FIGS. 2 and 3, the charge-discharge system 10 includes the power conditioner 100 and the charge-discharge device 200. In FIG. 2, five charge-discharge devices 200 are illustrated, and in FIG. 3, only one charge-discharge device 200 is illustrated for convenience of description, but the number of charge-discharge devices 200 included in the charge-discharge system 10 is not particularly limited. The number of power conditioners 100 included in the charge-discharge system 10 is also not particularly limited.

That is, as illustrated in FIG. 2, the charge-discharge system 10 may be disposed in a centralized charge-discharge station in which parking spaces S1 to S5 are arranged adjacent to each other, or may be disposed in a distributed charge-discharge station (not illustrated) in which the parking spaces are distributed (such as on another floor of a building). In FIG. 2, the charge-discharge device 200 is disposed in each of the parking spaces (S1, S2, . . . ), but the present invention is not limited to this mode, and a single charge-discharge device 200 may be installed in a single parking space. Plural vehicles 50 (vehicle energy storage apparatuses 51) may be connected to one charge-discharge device 200. In other words, the plural vehicles 50 (vehicle energy storage apparatuses 51) may be connected to the charge-discharge system 10, or only one vehicle 50 (one vehicle energy storage apparatus 51) may be connected to the charge-discharge system. The charge-discharge station in which the charge-discharge system 10 is disposed may be provided in a public place such as a public parking lot, or may be provided on the premises of a company or an individual.

As shown in FIG. 3, the power conditioner 100 is connected to the charge-discharge device 200, the power system 60, the power generation apparatus 70, the energy storage apparatus 80, and the power load 20, and exchanges power with these devices. That is, the power conditioner 100 receives power supply from the charge-discharge device 200, the power system 60, the power generation apparatus 70, and the energy storage apparatus 80, and supplies power to the charge-discharge device 200, the power system 60, the energy storage apparatus 80, and the power load 20.

The power system 60 is, for example, a commercial electric power system owned by an electric power company, and AC power generated by a system power supply 61 such as a thermal power plant flows therethrough. The power system 60 supplies the AC power to the power conditioner 100. The power generation apparatus 70 is a power generation apparatus installed in the supply area 1, and is a distributed power supply facility such as a solar power generation facility, a wind power generation facility, a diesel power generator, a small gas turbine power generator, a fuel cell, a micro hydraulic power generator, or binary power generation. The power generation apparatus 70 supplies the generated power to the power conditioner 100.

The energy storage apparatus 80 is a power supply apparatus capable of charging electricity from the outside and discharging electricity to the outside. The energy storage apparatus 80 charges power and discharges power via the power conditioner 100. Specifically, the energy storage apparatus 80 includes plural energy storage devices connected in series and/or in parallel. The energy storage device is a secondary battery (single battery) capable of charging and discharging electricity, and is, for example, a nonaqueous electrolyte secondary battery such as a lithium ion secondary battery. The energy storage device is not limited to the nonaqueous electrolyte secondary battery, and may be a secondary battery other than the nonaqueous electrolyte secondary battery, a capacitor, a primary battery, a battery using a solid electrolyte, or the like.

The power load 20 is a power load consumed in the supply area 1, and includes specific loads 21 and 22 used even in an emergency such as a power failure, and a general load 23 used in a normal time. The specific load 21 is a motive power load used in an elevator of a facility such as an office, commercial air conditioning, or the like, and the specific load 22 is an electric light load used for lighting, an outlet, or the like of a facility such as an office. The general load 23 is a power load other than the specific loads 21 and 22, and is a load for operating a machine in a home appliance or a factory.

The power conditioner 100 includes a first converter circuit 110, a second converter circuit 120, a bidirectional inverter circuit 130, a switching circuit 140, a controller 150, and a first communication unit 160.

The first converter circuit 110 is a power converter (DC/DC converter) that performs conversion between DC powers, is connected to the power generation apparatus 70, boosts an output voltage (DC) of the power generation apparatus 70, and outputs the boosted output voltage. The first converter circuit 110 may be a boost chopper. The second converter circuit 120 is a bidirectional power converter (bidirectional DC/DC converter) that performs conversion between DC powers, and is connected to the energy storage apparatus 80 to discharge and charge the energy storage apparatus 80. The second converter circuit 120 may be a bidirectional chopper. The energy storage apparatus 80 can store surplus power from the power generation apparatus 70 and power from the power system 60 via the second converter circuit 120. When the power generation amount of the power generation apparatus 70 is insufficient, the energy storage apparatus 80 can compensate for the shortage of the power generation amount through the second converter circuit 120 by discharging. The bidirectional inverter circuit 130 is a bidirectional conversion circuit that selectively performs reverse conversion (inverting) for converting DC power into AC power and forward conversion (converting) for converting AC power into DC power. The bidirectional inverter circuit 130 is connected to the first converter circuit 110, the second converter circuit 120, and the power system 60.

The switching circuit 140 is a circuit in which the three-phase specific load 21 and the single-phase specific load 22 are connected via a transformer, and a contact is switched in order to supply power to the specific loads 21 and 22 in an emergency such as a power failure of the power system 60. In a normal state, the switching circuit 140 is configured such that a contact A is connected to the power line and the power from the power system 60 can be supplied to the specific loads 21 and 22 and the like. In an emergency, the switching circuit 140 is configured such that the switching circuit is switched to a contact B and the power can be supplied from the power generation apparatus 70 and/or the energy storage apparatus 80 to the specific loads 21 and 22 via the bidirectional inverter circuit 130. As a result, during the power failure of the power system 60, backup power is supplied from at least one of the power generation apparatus 70, the energy storage apparatus 80, and the charge-discharge device 200 to the specific loads 21 and 22.

The controller 150 is a control device that controls various devices in the power conditioner 100. The power conditioner 100 further includes a current detector and a voltage detector (not illustrated). The current detector is, for example, a through hole sensor, and detects a current flowing through a power line in the power conditioner 100. The voltage detector detects a voltage of a power line in the power conditioner 100. The controller 150 has a function of calculating and acquiring power (active power) and an amount of power flowing in and out of the power line on the basis of the detected current and voltage. The controller 150 also has a function of calculating received power from a received power current and a system voltage detected by an external measuring instrument (external transducer) 62 provided at a receiving point of the power system 60, or acquiring the received power calculated by the external measuring instrument 62. As described above, the controller 150 is configured to be able to acquire the power and the amount of power of the current flowing between the charge-discharge system 10 and the power system 60, the power generation apparatus 70, the energy storage apparatus 80, and the power load 20. The controller 150 may be configured to be able to acquire information other than the above, such as a state of charge (SOC) of the energy storage apparatus 80 and the power and the amount of power of the current flowing between the power conditioner 100 and the charge-discharge device 200.

The first communication unit 160 is a communication board such as a network interface card (NIC), and can communicate with an external device. The first communication unit 160 is communicably connected to the controller 150 via a communication line (not illustrated), and acquires information from the controller 150. The first communication unit 160 is also communicably connected to a second communication unit 230 of the charge-discharge device 200 described later via a communication line or by wireless communication, and also acquires information from the second communication unit 230. The first communication unit 160 generates display data by using the acquired information, and transmits the display data to the client device 40 (display device 41). The first communication unit 160 will be described in detail later.

The power conditioner 100 may be a three-phase interconnection energy storage system capable of supplying power to a wide range of power loads. For example, space saving can be achieved by using, as the power conditioner 100, a so-called storage battery-equipped power conditioner integrally provided with the energy storage apparatus 80.

The charge-discharge device 200 is a charge-discharge stand that is connected to the vehicle energy storage apparatus 51 which is an energy storage apparatus included in the vehicle 50 and performs charge-discharge with the vehicle energy storage apparatus 51. The charge-discharge device 200 is also connected to the power load 20 via the power conditioner 100, charges the vehicle energy storage apparatus 51 in a normal time or the like, and discharges the vehicle energy storage apparatus 51 in an emergency or the like to supply power to the power load 20 or the like such as the specific loads 21 and 22.

The vehicle 50 is an automobile (moving body) such as an electric vehicle (EV) and a plug-in hybrid electric vehicle (PHEV), and the vehicle energy storage apparatus 51 is a battery mounted thereon. Similarly to the energy storage apparatus 80, the vehicle energy storage apparatus 51 includes plural energy storage devices (lithium ion secondary batteries and the like) connected in series and/or in parallel.

The charge-discharge device 200 includes a charge-discharge unit 210, a controller 220, and a second communication unit 230.

The charge-discharge unit 210 is a bidirectional conversion circuit that selectively performs forward conversion (conversion) for converting AC power into DC power and reverse conversion (inversion) for converting DC power into AC power. The charge-discharge unit 210 converts AC power from the power conditioner 100 into DC power, and supplies the DC power to the vehicle energy storage apparatus 51 to charge the vehicle energy storage apparatus 51. The charge-discharge unit 210 converts DC power discharged from the vehicle energy storage apparatus 51 into AC power, and supplies the AC power to the power load 20 and the like via the power conditioner 100.

The controller 220 controls the charge-discharge unit 210 by giving a command to the charge-discharge unit 210. The controller 220 has a function of calculating (estimating) and acquiring the power and the amount of power at the time of charging and discharging the vehicle energy storage apparatus 51 on the basis of the output of the charge-discharge unit 210. The controller 220 may have a function of acquiring and monitoring the SOC of the vehicle energy storage apparatus 51. The controller 220 may include a storage unit (memory), a display panel, an operation unit, and the like.

The second communication unit 230 is a communication board such as a network interface card (NIC) that can communicate with the first communication unit 160 of the power conditioner 100 through a communication line or by wireless communication. The second communication unit 230 acquires various types of information from the controller 220 and transmits the information to the first communication unit 160. Specifically, the second communication unit 230 acquires power, an amount of power, and the like charged and discharged between the vehicle energy storage apparatus 51 and the charge-discharge unit 210 (charge-discharge system 10) from the controller 220, and transmits the power, the amount of power, and the like to the first communication unit 160. As described above, in the present embodiment, the first communication unit 160 functions as a master unit, and the second communication unit 230 functions as a slave unit.

When plural charge-discharge devices 200 are provided in the charge-discharge system 10 as shown in FIG. 2, plural second communication units 230 included in the charge-discharge devices 200 are configured to be able to communicate with the first communication unit 160, and information is transmitted from the plurality of second communication units 230 to the first communication unit 160. The second communication unit 230 may be configured to be able to communicate with the other second communication unit 230 included in the other charge-discharge device 200 in a wired or wireless manner, and may be configured to acquire information from the other second communication unit 230 and then transmit the information to the first communication unit 160.

### [2 Description of First Communication Unit 160]

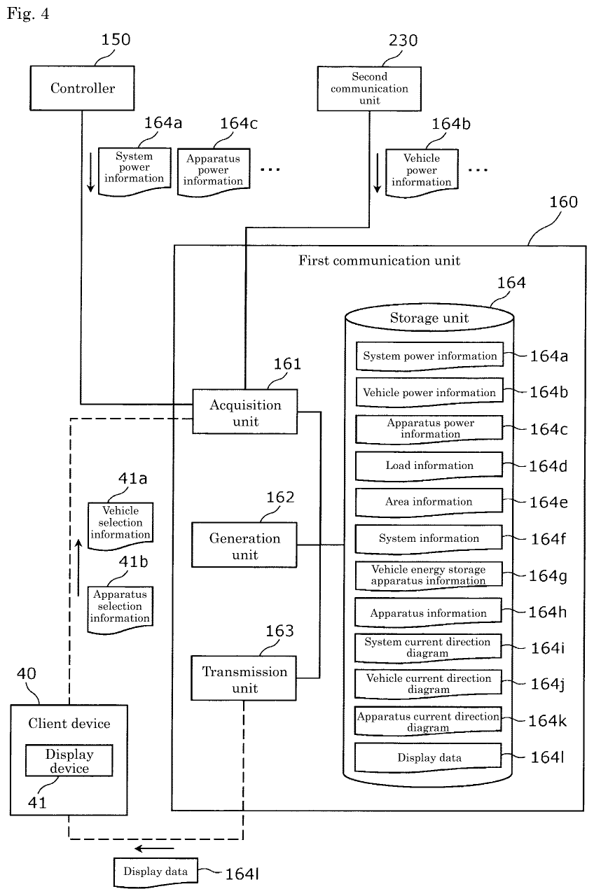

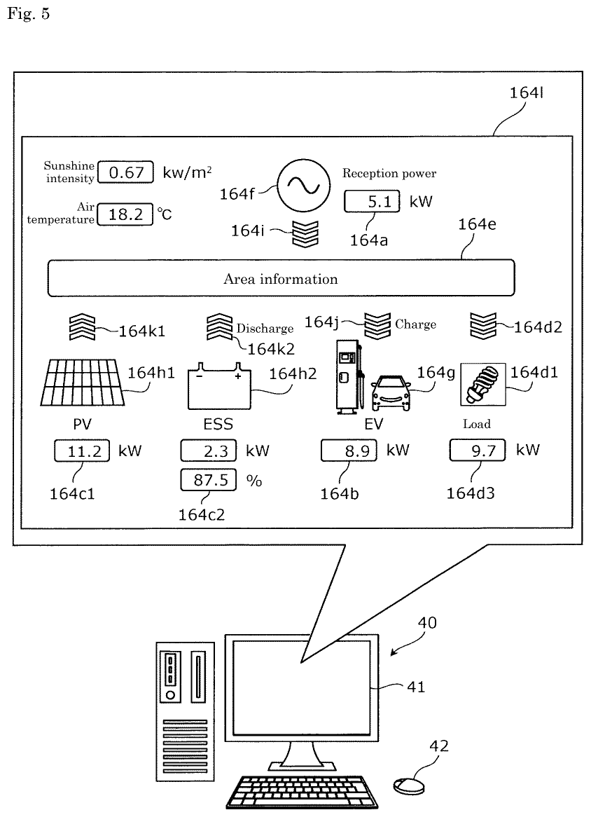

Next, the first communication unit 160 included in the power conditioner 100 of the charge-discharge system 10 will be described in detail. FIG. 4 is a block diagram illustrating a functional configuration of the first communication unit 160 according to the present embodiment. FIG. 4 illustrates a configuration in which the first communication unit 160 acquires information from the controller 150 and the second communication unit 230 and transmits the information to the client device 40 (display device 41). FIG. 5 is a diagram illustrating an example of display data 164l displayed on the display device 41 according to the present embodiment. In FIG. 5, a monitor of a personal computer is illustrated as an example of the display device 41, but a touch panel of a smartphone or a tablet type communication terminal may be used.

As illustrated in FIG. 4, the first communication unit 160 includes an acquisition unit 161, a generation unit 162, a transmission unit 163, and a storage unit 164.

The acquisition unit 161 acquires various types of information such as system power information 164a, vehicle power information 164b, and apparatus power information 164c. The acquisition unit 161 acquires the system power information 164a, the apparatus power information 164c, and the like from the controller 150 of the power conditioner 100, and acquires the vehicle power information 164b and the like from the second communication unit 230 of the charge-discharge device 200. The acquisition unit 161 writes and stores various types of information such as the acquired system power information 164a, vehicle power information 164b, and apparatus power information 164c in the storage unit 164.

The system power information 164a is information indicating power flowing between the power system 60 and the charge-discharge system 10. The system power information 164a includes information indicating power of a forward power flow flowing from the power system 60 to the charge-discharge system 10 (supply area 1) and information indicating power of a reverse power flow flowing from the charge-discharge system 10 (supply area 1) to the power system 60. That is, the system power information 164a includes information such as a magnitude of power (value of power) of a current flowing between the power system 60 and the charge-discharge system 10 and a flow direction (positive, negative, or the like) of the current.

The vehicle power information 164b is information indicating power charged and discharged between the vehicle energy storage apparatus 51 and the charge-discharge system 10. The vehicle power information 164b includes information indicating power charged from the charge-discharge system 10 to the vehicle energy storage apparatus 51, and information indicating power discharged from the vehicle energy storage apparatus 51 to the charge-discharge system 10. That is, the vehicle power information 164b includes information such as the magnitude of the power (value of power) of the current flowing between the vehicle energy storage apparatus 51 and the charge-discharge system 10 and the flow direction (positive, negative, or the like) of the current.

The apparatus power information 164c is information indicating power flowing between at least one of the power generation apparatus 70 and the energy storage apparatus 80 and the charge-discharge system 10. In the present embodiment, the apparatus power information 164c is information indicating power flowing between both the power generation apparatus 70 and the energy storage apparatus 80 and the charge-discharge system 10. The apparatus power information 164c includes information indicating power generated by the power generation apparatus 70 and supplied to the charge-discharge system 10, information indicating power charged from the charge discharge system 10 to the energy storage apparatus 80, and information indicating power discharged from the energy storage apparatus 80 to the charge-discharge system 10. That is, the apparatus power information 164c includes information such as the magnitude (value of power) of the power of the current flowing between both the power generation apparatus 70 and the energy storage apparatus 80 and the charge-discharge system 10, and the flow direction (positive, negative, or the like) of the current.

When plural vehicle energy storage apparatuses 51 are connected to the charge-discharge system 10, the acquisition unit 161 is configured to be able to acquire vehicle selection information 41a. The vehicle selection information 41a is information indicating that vehicle energy storage apparatus information 164g or vehicle current direction diagram 164j displayed on the display device 41 of the client device 40 has been selected. That is, when the user selects (clicks or the like) the vehicle energy storage apparatus information 164g or the vehicle current direction diagram 164j displayed on the display device 41 of the client device 40, the vehicle selection information 41a indicating the selection is transmitted from the client device 40 (display device 41) to the acquisition unit 161. The acquisition unit 161 acquires the vehicle selection information 41a transmitted from the client device 40 (display device 41).

When plural power generation apparatuses 70 or plural energy storage apparatuses 80 are connected to the charge-discharge system 10, the acquisition unit 161 is configured to be able to acquire the apparatus selection information 41b. The apparatus selection information 41b is information indicating that apparatus information 164h or an apparatus current direction diagram 164k displayed on the display device 41 of the client device 40 has been selected. That is, when the user selects (clicks or the like) the apparatus information 164h or the apparatus current direction diagram 164k displayed on the display device 41 of the client device 40, the apparatus selection information 41b indicating the selection is transmitted from the client device 40 (display device 41) to the acquisition unit 161. The acquisition unit 161 acquires the apparatus selection information 41b transmitted from the client device 40 (display device 41).

The generation unit 162 generates display data 164l for causing the display device 41 of the client device 40 to display a screen including various types of information as illustrated in FIG. 5. Specifically, the generation unit 162 generates the display data 164l for causing the display device 41 to display a screen including area information 164e, system information 164f, vehicle energy storage apparatus information 164g, system current direction diagram 164i, vehicle current direction diagram 164j, and load information 164d. The generation unit 162 generates the display data 164l for causing the display device 41 to display a screen further including apparatus information 164h and apparatus current direction diagram 164k. The generation unit 162 generates the display data 164l for causing the display device 41 to display a screen further including information indicating the magnitude of power indicated by each of system power information 164a, vehicle power information 164b, apparatus power information 164c, and load information 164d. The generation unit 162 generates the display data 164l of a screen further including information indicating solar radiation intensity and air temperature in the supply area 1.

The area information 164e is information indicating the supply area 1. The area information 164e is a character, a symbol, a diagram, or the like (in FIG. 5, characters) that can identify the target supply area 1, such as A district B building, A district C office, or D company. The system information 164f is information indicating the power system 60. The system information 164f is a character, a symbol, a diagram, or the like (in FIG. 5, a diagram) that can identify the power system 60. The vehicle energy storage apparatus information 164g is information indicating the vehicle energy storage apparatus 51. The vehicle energy storage apparatus information 164g is a character, a symbol, a diagram, or the like (in FIG. 5, a diagram and characters “EV”) that can identify the vehicle energy storage apparatus 51. The apparatus information 164h is information indicating at least one of the power generation apparatus 70 and the energy storage apparatus 80. The apparatus information 164h is a character, a symbol, a diagram, or the like that can identify at least one of the power generation apparatus 70 and the energy storage apparatus 80. In FIG. 5, the information indicating the power generation apparatus 70 is indicated by a diagram and characters “PV” as apparatus information 164h1, and the information indicating the energy storage apparatus 80 is indicated by a diagram and characters “ESS” as apparatus information 164h2.

The system current direction diagram 164i is a diagram indicating the direction of current of the power indicated by the system power information 164a. In FIG. 5, as the system current direction diagram 164i, the direction of current of the power of the forward power flow flowing from the power system 60 to the charge-discharge system 10 (supply area 1) is indicated by a diagram of an arrow directed from the system information 164f to the area information 164e. As the information indicating the magnitude of the power indicated by the system power information 164a, the value of power (kW) flowing from the power system 60 to the charge-discharge system 10 (supply area 1) is indicated.

The vehicle current direction diagram 164j is a diagram indicating the direction of current of the power indicated by the vehicle power information 164b. In FIG. 5, as the vehicle current direction diagram 164j, the direction of current of the power flowing (charged) from the charge-discharge system 10 to the vehicle energy storage apparatus 51 is indicated by a diagram of an arrow directed from the area information 164e to the vehicle energy storage apparatus information 164g. As the information indicating the magnitude of power indicated by the vehicle power information 164b, the value of power (kW) flowing (charged) from the area information 164e to the vehicle energy storage apparatus information 164g is indicated.

The apparatus current direction diagram 164k is a diagram indicating the direction of current of the power indicated by the apparatus power information 164c. In FIG. 5, a diagram indicating the direction of current of the power flowing between the power generation apparatus 70 and the charge-discharge system 10 is defined as an apparatus current direction diagram 164k1, and a diagram indicating the direction of current of the power flowing between the energy storage apparatus 80 and the charge-discharge system 10 is defined as an apparatus current direction diagram 164k2. As the apparatus current direction diagram 164k1, the direction of current of the power flowing from the power generation apparatus 70 to the charge-discharge system 10 is indicated by a diagram of an arrow directed from the apparatus information 164h1 to the area information 164e. As the apparatus current direction diagram 164k2, the direction of current of the power flowing from the energy storage apparatus 80 to the charge-discharge system 10 is indicated by a diagram of an arrow directed from the apparatus information 164h2 to the area information 164e. As the information indicating the magnitude of the power indicated by the apparatus power information 164c, the value of power (kW) flowing (generated) from the power generation apparatus 70 to the charge-discharge system 10 is defined as the apparatus power information 164c1. The value of power (kW) flowing (discharged) from the energy storage apparatus 80 to the charge-discharge system 10 is defined as apparatus power information 164c2. The apparatus power information 164c2 also includes the SOC value (%) of the energy storage apparatus 80.

The load information 164d is information indicating a power consumption state of the power load 20. In FIG. 5, information indicating the power load 20 (Specific loads 21 and 22 and general load 23) is load information 164d1, a diagram indicating the direction of current of the power flowing between the charge-discharge system 10 and the power load 20 is load information 164d2, and information indicating the magnitude of the power load 20 is load information 164d3. The load information 164d1 is a character, a symbol, a diagram, or the like (in FIG. 5, a diagram and characters “load”) that can identify the power load 20. As the load information 164d2, the direction of current of the power flowing from the charge-discharge system 10 to the power load 20 is indicated by a diagram of an arrow directed from the area information 164e to the load information 164d1. The load information 164d1 is a value (kW) of power consumption of the power load 20.

The generation unit 162 generates display data 164l for causing the display device 41 to display a screen on which system information 164f and system current direction diagram 164i are located above the area information 164e, and vehicle energy storage apparatus information 164g, vehicle current direction diagram 164j, and load information 164d are located below the area information 164e. The generation unit 162 generates the display data 164l for causing the display device 41 to display a screen on which the apparatus information 164h and the apparatus current direction diagram 164k are located below the area information 164e. The generation unit 162 generates the display data 164l of a screen on which the information indicating the magnitude of the power indicated by the system power information 164a is located above the area information 164e, and the information indicating the magnitude of the power indicated by each of the vehicle power information 164b, the apparatus power information 164c, and the load information 164d is located below the area information 164e.

The generation unit 162 determines at least one of whether or not the power indicated by the system power information 164a is zero and whether or not the power indicated by the vehicle power information 164b is zero. The generation unit 162 generates, when determining that the power indicated by the system power information 164a is zero, the display data 164l for causing the display device 41 to display a screen including the system current direction diagram 164i different from the case where the power is not zero or a screen not including the system current direction diagram 164i. The generation unit 162 generates, when determining that the power indicated by the vehicle power information 164b is zero, the display data 164l for causing the display device 41 to display a screen including the vehicle current direction diagram 164j different from the case where the power is not zero or a screen not including the vehicle current direction diagram 164j.

The generation unit 162 determines whether or not the vehicle energy storage apparatus 51 is connected to the charge-discharge system 10. The generation unit 162 generates, when determining that the vehicle energy storage apparatus 51 is not connected to the charge-discharge system 10, the display data 164l for causing the display device 41 to display a screen including the vehicle energy storage apparatus information 164g different from the case of determining that the vehicle energy storage apparatus 51 is connected to the charge-discharge system 10 or a screen not including the vehicle energy storage apparatus information 164g.

The generation unit 162 generates, when the acquisition unit 161 has not acquired the vehicle selection information 41a, the display data 164l for causing the display device 41 to display a screen including the vehicle energy storage apparatus information 164g and the vehicle current direction diagram 164j by regarding the plurality of vehicle energy storage apparatuses 51 as one vehicle energy storage apparatus. The generation unit 162 generates, when the acquisition unit 161 has acquired the vehicle selection information 41a, the display data 164l for causing the display device 41 to display a screen including the vehicle energy storage apparatus information 164g and the vehicle current direction diagram 164j for each of the vehicle energy storage apparatuses 51.

The generation unit 162 generates, when the acquisition unit 161 has not acquired the apparatus selection information 41b, the display data 164l for causing the display device 41 to display a screen including the apparatus information 164h and the apparatus current direction diagram 164k by regarding the plurality of power generation apparatuses 70 or the plurality of energy storage apparatuses 80 as one power generation apparatus or one energy storage apparatus. The generation unit 162 generates, when the acquisition unit 161 has acquired the apparatus selection information 41b, the display data 164l for causing the display device 41 to display a screen including the apparatus information 164h and the apparatus current direction diagram 164k for each of the power generation apparatuses 70 or the plurality of energy storage apparatuses 80.

The above processing in which the generation unit 162 generates the display data 164l will be described in detail later. Various types of information necessary for the generation unit 162 to generate the display data 164l are stored in the storage unit 164, and the generation unit 162 reads and acquires the information from the storage unit 164. These pieces of information may be stored in the storage unit 164 in advance, or the information acquired by the acquisition unit 161 may be written and stored in the storage unit 164. The generation unit 162 may acquire information from a processing unit (input from the user or the like) other than the storage unit 164. The generation unit 162 writes and stores the generated display data 164l in the storage unit 164.

The transmission unit 163 transmits display data 164l to the display device 41. The transmission unit 163 reads and acquires the display data 164l generated by the generation unit 162 and stored in the storage unit 164 from the storage unit 164, and transmits the display data 164l to the client device 40 (display device 41). As a result, as illustrated in FIG. 5, the display data 164l is displayed on the display device 41 of the client device 40.

The storage unit 164 is a memory that stores data necessary for the generation unit 162 to generate the display data 164l, such as the data acquired by the acquisition unit 161, the display data 164l generated by the generation unit 162, and the like. Specifically, the storage unit 164 stores system power information 164a, vehicle power information 164b, apparatus power information 164c, load information 164d, area information 164e, system information 164f, vehicle energy storage apparatus information 164g, apparatus information 164h, a system current direction diagram 164i, a vehicle current direction diagram 164j, an apparatus current direction diagram 164k, display data 164l, and the like. The storage unit 164 may store data other than the above data, such as data in the middle of the generation unit 162 generating the display data 164l. In the storage unit 164, in a case where there is a change in these pieces of data, these pieces of data are updated each time, but these pieces of data may be accumulated.

### [3 Description of Processing Flow of Charge-Discharge System 10]

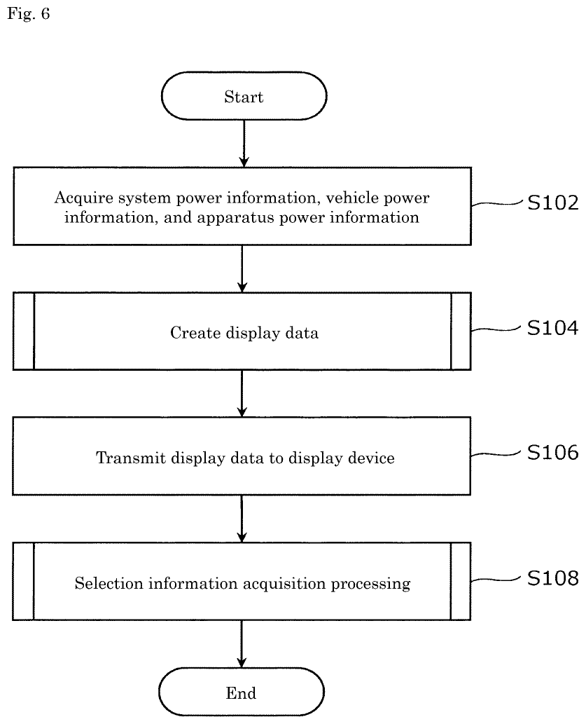

Next, processing performed by the charge-discharge system 10 (a method for controlling the charge-discharge system 10) will be described. FIG. 6 is a flowchart showing processing (a method for controlling the charge-discharge system) performed by the charge-discharge system 10 according to the present embodiment. FIG. 6 illustrates processing performed by each processing unit of the first communication unit 160 included in the power conditioner 100 of the charge-discharge system 10.

As illustrated in FIG. 6, first, the acquisition unit 161 acquires various types of information such as system power information 164a, vehicle power information 164b, and apparatus power information 164c (S102). Details of each piece of information acquired by the acquisition unit 161 are as described above, and thus description thereof is omitted.

Then, the generation unit 162 generates the display data 164l using the information and the like acquired by the acquisition unit 161 (S104). The generation unit 162 generates display data 164l for causing the display device 41 to display a screen including the area information 164e, the system information 164f, the vehicle energy storage apparatus information 164g, the system current direction diagram 164i, the vehicle current direction diagram 164j, the load information 164d, and the like. Since the details of each piece of information are as described above, the description thereof will be omitted. The processing of generating the display data 164l by the generation unit 162 will be described in detail later.

Then, the transmission unit 163 transmits the display data 164l generated by the generation unit 162 to the display device 41 of the client device 40 (S106).

Thereafter, when the acquisition unit 161 acquires the vehicle selection information 41a or the apparatus selection information 41b, selection information acquisition processing by the generation unit 162 is performed (S108). The selection information acquisition processing performed by the generation unit 162 will be described in detail later.

As described above, the processing (method for controlling the charge-discharge system) performed by the charge-discharge system 10 (first communication unit 160) ends.

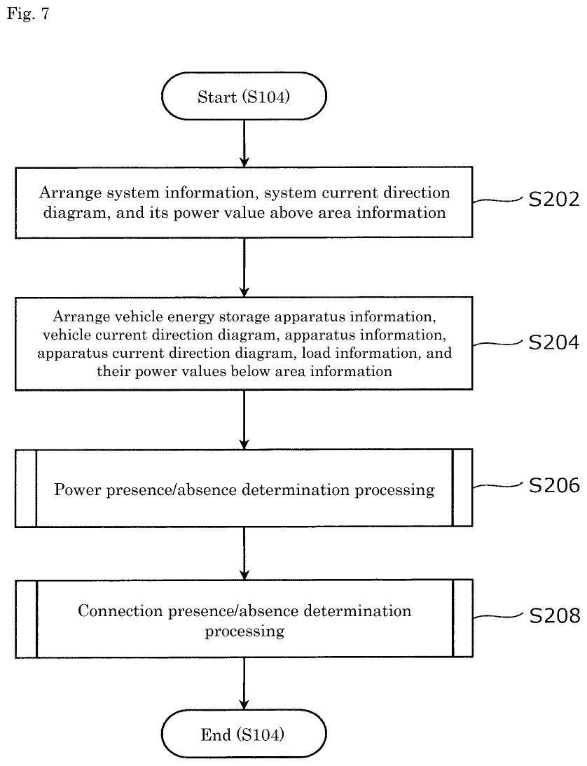

Next, the processing in which the generation unit 162 generates the display data 164l (S104 in FIG. 6) will be described in detail. FIG. 7 is a flowchart illustrating processing in which the generation unit 162 of the first communication unit 160 according to the present embodiment generates the display data 164l.

As illustrated in FIG. 5, the generation unit 162 generates display data 164l for causing the display device 41 to display the following screen.

The generation unit 162 arranges the system information 164f, the system current direction diagram 164i, and the system power information 164a (value of power) above the area information 164e (above when the screen of the display device 41 is erected and viewed) (S202). The generation unit 162 arranges these pieces of information at a substantially central position of the area information 164e in the left-right direction. The generation unit 162 arranges the system information 164f and the system current direction diagram 164i so as to be arranged in this order toward the area information 164e (downward), and arranges the system information 164f and the system current direction diagram 164i on the left side of the system power information 164a (value of power).

As described below, the generation unit 162 arranges the information below the area information 164e (below when the screen of display device 41 is erected and viewed) (S204). The generation unit 162 arranges the vehicle current direction diagram 164j, the vehicle energy storage apparatus information 164g, and the vehicle power information 164b (value of power) below the area information 164e such that the vehicle current direction diagram 164j, the vehicle energy storage apparatus information 164g, and the vehicle power information 164b are arranged in this order downward from the area information 164e. The generation unit 162 arranges the apparatus current direction diagram 164k (164k1, 164k2), the apparatus information 164h (164h1, 164h2), and the apparatus power information 164c (164c1, 164c2) (value of power) below the area information 164e such that the apparatus current direction diagram 164k, the apparatus information 164h, and the apparatus power information 164c are arranged in this order downward from the area information 164e. The generation unit 162 arranges the load information 164d2 (arrow), the load information 164d1 (diagram), and the load information 164d3 (value of power) as the load information 164d below the area information 164e such that the load information 164d2, the load information 164d1, and the load information 164d3 are arranged in this order downward from the area information 164e. The generation unit 162 arranges the apparatus information 164h1, the apparatus information 164h2, the vehicle energy storage apparatus information 164g, and the load information 164d1 in this order from the left side to the right side in this order.

The generation unit 162 performs power presence/absence determination processing of determining the presence/absence of power with the charge-discharge system 10 and generating the display data 164l (S206). The power presence/absence determination processing will be described in detail later.

The generation unit 162 performs connection presence/absence determination processing of determining whether or not to be connected to the charge-discharge system 10 and generating the display data 164l (S208). The connection presence/absence determination processing will be described in detail later.

As described above, the processing in which the generation unit 162 generates the display data 164l (S104 in FIG. 6) ends.

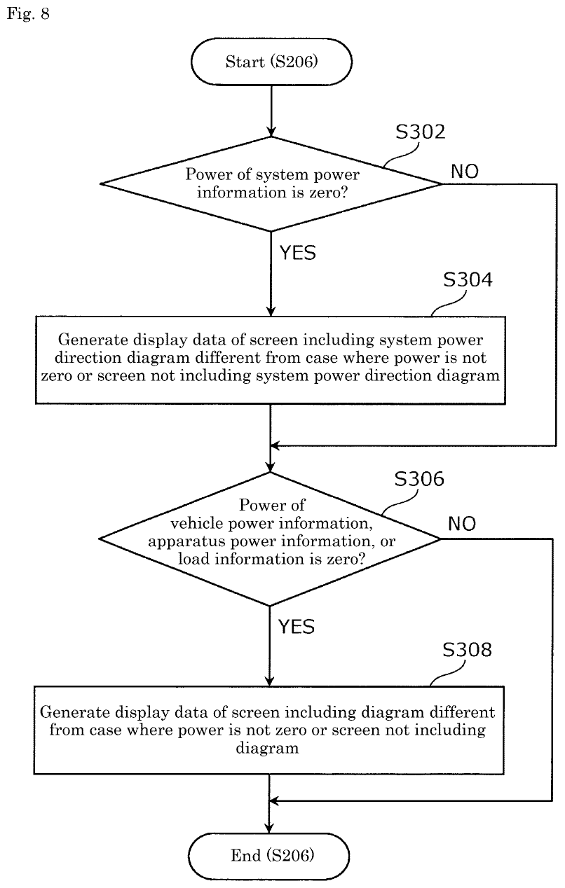

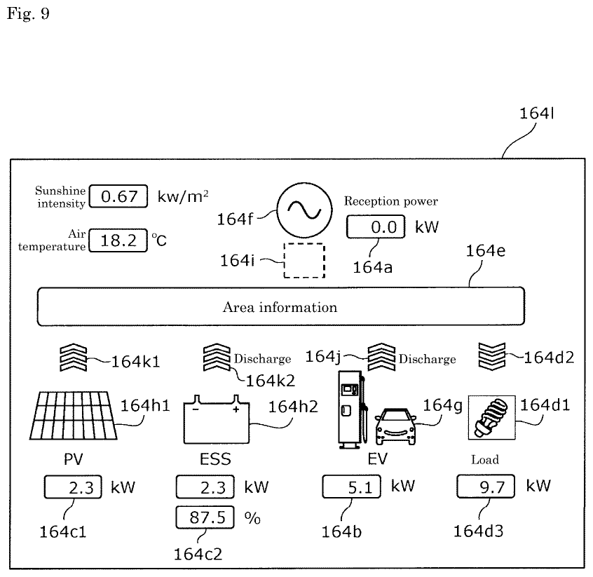

Next, the power presence/absence determination processing (S206 in FIG. 7) performed by the generation unit 162 will be described in detail. FIG. 8 is a flowchart illustrating the power presence/absence determination processing performed by the generation unit 162 according to the present embodiment. FIG. 9 is a diagram illustrating an example of the display data 164l generated by the generation unit 162 according to the present embodiment performing the power presence/absence determination processing.

As illustrated in FIG. 8, the generation unit 162 determines whether or not the power indicated by the system power information 164a is zero (S302). The generation unit 162 generates, when determining that the power indicated by the system power information 164a is zero (YES in S302), the display data 164l for causing the display device 41 to display a screen including the system current direction diagram 164i different from the case where the power is not zero or a screen not including the system current direction diagram 164i (S304). The generation unit 162 does not perform the above processing (S304) when determining that the power indicated by the system power information 164a is not zero (NO in S302).

In the case illustrated in FIG. 9, since the value of power of the system power information 164a is zero, the generation unit 162 determines that the power indicated by the system power information 164a is zero, and generates the display data 164l so as not to display the system current direction diagram 164i. In FIG. 9, the generation unit 162 may generate the display data 164l so as to display the system current direction diagram 164i (such as a cross mark) different from the diagram (arrow) when the value of power of the system power information 164a is not zero.

The generation unit 162 also determines whether or not the power indicated by the vehicle power information 164b is zero (S306). The generation unit 162 generates, when determining that the power indicated by the vehicle power information 164b is zero (YES in S306), the display data 164l for causing the display device 41 to display a screen including the vehicle current direction diagram 164j different from the case where the power is not zero or a screen not including the vehicle current direction diagram 164j (S308). The generation unit 162 does not perform the above processing (S308) when determining that the power indicated by the vehicle power information 164b is not zero (NO in S306).

Similarly to the example of FIG. 9, when the value of power of the vehicle power information 164b is zero, the generation unit 162 determines that the power indicated by the vehicle power information 164b is zero, and generates the display data 164l so as not to display the vehicle current direction diagram 164j. The generation unit 162 may generate the display data 164l so as to display a vehicle current direction diagram 164j (such as a cross mark) different from the diagram (arrow) when the value of power of the vehicle power information 164b is not zero.

Similarly in the apparatus power information 164cl, the apparatus power information 164c2, or the load information 164d3, the generation unit 162 may determine whether or not the power indicated by the information is zero and perform the same processing as described above.

As described above, the power presence/absence determination processing (S206 in FIG. 7) performed by the generation unit 162 ends.

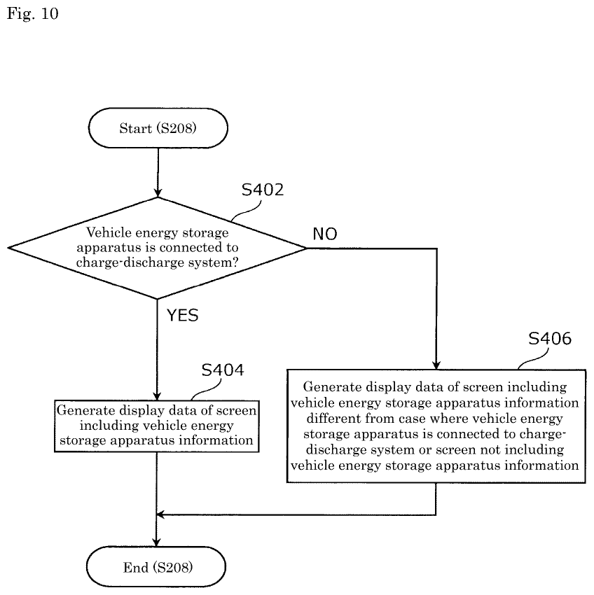

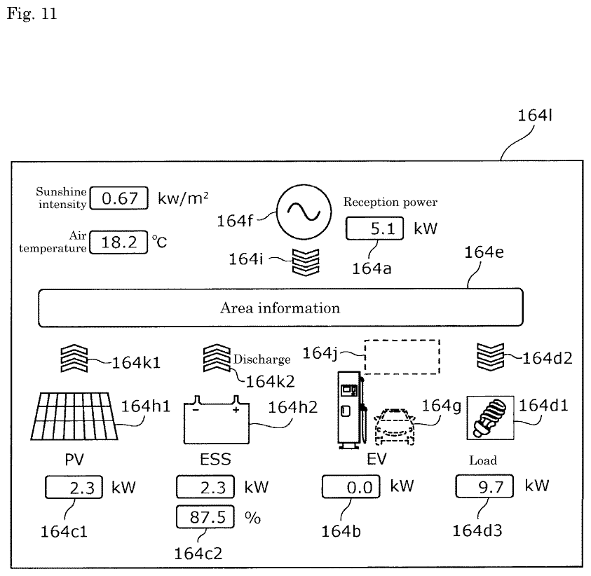

Next, the connection presence/absence determination processing (S208 in FIG. 7) performed by the generation unit 162 will be described in detail. FIG. 10 is a flowchart illustrating the connection presence/absence determination processing performed by the generation unit 162 according to the present embodiment. FIG. 11 is a diagram illustrating an example of the display data 164l generated by the generation unit 162 according to the present embodiment performing the connection presence/absence determination processing.

As shown in FIG. 10, the generation unit 162 determines whether or not the vehicle energy storage apparatus 51 is connected to the charge-discharge system 10 (S402). The generation unit 162 generates, when determining that the vehicle energy storage apparatus 51 is connected to the charge-discharge system 10 (YES in S402), the display data 164l for causing the display device 41 to display a screen including the vehicle energy storage apparatus information 164g (S404).

The generation unit 162 generates, when determining that the vehicle energy storage apparatus 51 is not connected to the charge-discharge system 10 (NO in S402), the display data 164l for causing the display device 41 to display a screen including the vehicle energy storage apparatus information 164g different from the case of determining that the vehicle energy storage apparatus 51 is connected to the charge-discharge system 10 or a screen not including the vehicle energy storage apparatus information 164g (S406).

FIG. 11 shows a case where the vehicle energy storage apparatus 51 is not connected to the charge-discharge system 10. In this case, the generation unit 162 generates the display data 164l for causing the display device 41 to display a screen including the vehicle energy storage apparatus information 164g (dotted line vehicle) different from the diagram (solid line vehicle shown in FIG. 5 and the like) when determining that the vehicle energy storage apparatus 51 is connected to the charge-discharge system 10. In FIG. 11, instead of the dotted line, the generation unit 162 may generate the display data 164l so as to display the vehicle energy storage apparatus information 164g in which “x” is added to the vehicle or the color of the vehicle is changed, or so as not to display the vehicle energy storage apparatus information 164g. When the vehicle energy storage apparatus 51 is not connected to the charge-discharge system 10, the power indicated by the vehicle power information 164b becomes zero, and thus the generation unit 162 generates the display data 164l so as not to display the vehicle current direction diagram 164j by the above-described power presence/absence determination processing.

The generation unit 162 may similarly determine whether or not the power generation apparatus 70, the energy storage apparatus 80, or the power load 20 is connected to the charge-discharge system 10, and perform the same processing as described above.

As described above, the connection presence/absence determination processing (S208 in FIG. 7) performed by the generation unit 162 ends.

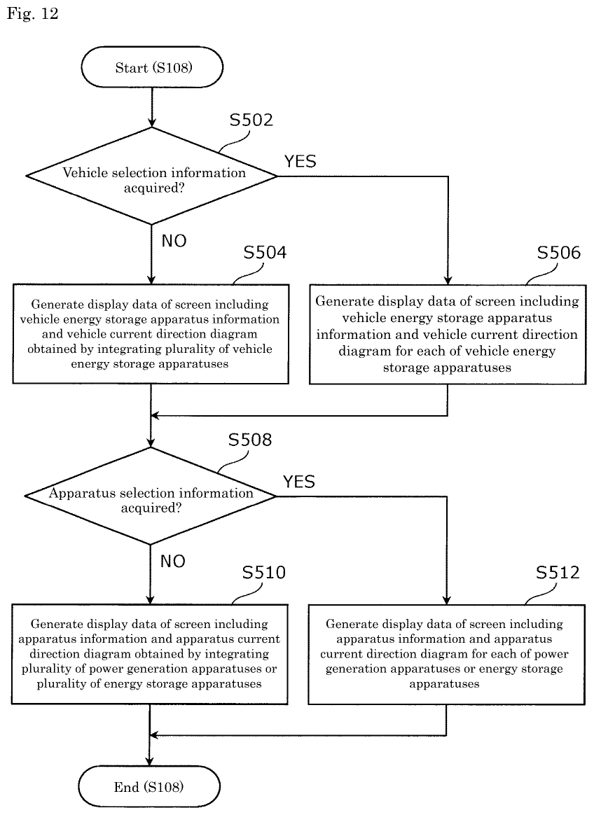

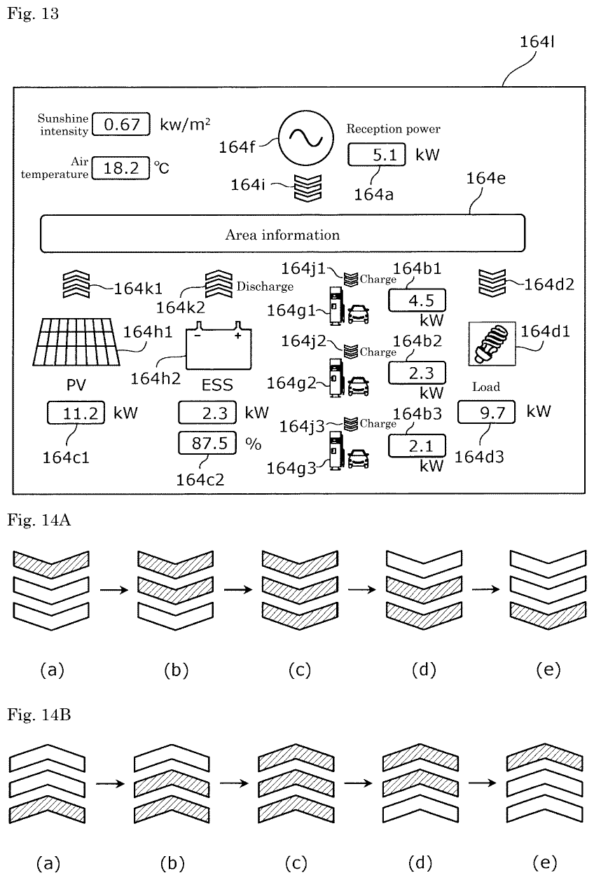

Next, the selection information acquisition processing (S108 in FIG. 6) performed by the generation unit 162 will be described in detail. FIG. 12 is a flowchart illustrating the selection information acquisition processing performed by the generation unit 162 according to the present embodiment. FIG. 13 is a diagram illustrating an example of the display data 164l generated by the generation unit 162 according to the present embodiment performing the selection information acquisition processing.

As illustrated in FIG. 12, the generation unit 162 determines whether or not the acquisition unit 161 has acquired the vehicle selection information 41a (S502). When the user selects the vehicle energy storage apparatus information 164g or the vehicle current direction diagram 164j displayed on the display device 41 of the client device 40 by clicking or touching the vehicle energy storage apparatus information 164g or the vehicle current direction diagram 164j via the input device 42, the vehicle selection information 41a is transmitted to the acquisition unit 161. When the acquisition unit 161 acquires the vehicle selection information 41a, the generation unit 162 determines that the acquisition unit 161 has acquired the vehicle selection information 41a.

The generation unit 162 generates, when determining that the acquisition unit 161 has not acquired the vehicle selection information 41a (NO in S502), the display data 164l for causing the display device 41 to display a screen including the vehicle energy storage apparatus information 164g and the vehicle current direction diagram 164j, by regarding the plurality of vehicle energy storage apparatuses 51 as one vehicle energy storage apparatus (S504). As shown in FIG. 5, the generation unit 162 generates the display data 164l of a screen including one piece of vehicle energy storage apparatus information 164g, one vehicle current direction diagram 164j, and one piece of vehicle power information 164b (value of power).

The generation unit 162 generates, when determining that the acquisition unit 161 has acquired the vehicle selection information 41a (YES in S502), the display data 164l for causing the display device 41 to display a screen including the vehicle energy storage apparatus information 164g and the vehicle current direction diagram 164j for each of the vehicle energy storage apparatuses 51 (S506). FIG. 13 shows an example in which three vehicle energy storage apparatuses 51 are connected to the charge-discharge system 10. In this case, the generation unit 162 generates the display data 164l of a screen including three pieces of vehicle energy storage apparatus information 164g1 to 164g3, three vehicle current direction diagrams 164j1 to 164j3, and three pieces of vehicle power information 164b1 to 164b3 for each of the three vehicle energy storage apparatuses 51.

Next, the generation unit 162 determines whether or not the acquisition unit 161 has acquired the apparatus selection information 41b (S508). When the user selects the apparatus information 164h or the apparatus current direction diagram 164k displayed on the display device 41 of the client device 40 by clicking or touching the apparatus information 164h or the apparatus current direction diagram 164k via the input device 42, the apparatus selection information 41b is transmitted to the acquisition unit 161. When the acquisition unit 161 acquires the apparatus selection information 41b, the generation unit 162 determines that the acquisition unit 161 has acquired the apparatus selection information 41b.

The generation unit 162 generates, when determining that the acquisition unit 161 has not acquired the apparatus selection information 41b (NO in S508), the display data 164l for causing the display device 41 to display a screen including the apparatus information 164h and the apparatus current direction diagram 164k by regarding the plurality of power generation apparatuses 70 or the plurality of energy storage apparatuses 80 as one power generation apparatus or one energy storage apparatus (S510). As illustrated in FIG. 5, the generation unit 162 generates the display data 164l of a screen including one piece of apparatus information 164h, one apparatus current direction diagram 164k, and one piece of apparatus power information 164c (value of power).

The generation unit 162 generates, when determining that the acquisition unit 161 has acquired the apparatus selection information 41b (YES in S508), the display data 164l for causing the display device 41 to display a screen including the apparatus information 164h and the apparatus current direction diagram 164k for each of the power generation apparatuses 70 and the plurality of energy storage apparatuses 80 (S512). It is assumed that a plurality of power generation apparatuses 70 are connected to the charge-discharge system 10, and the apparatus selection information 41b is information indicating that the apparatus information 164h1 or the apparatus current direction diagram 164k1 displayed on the display device 41 has been selected. In this case, the generation unit 162 generates the display data 164l of the screen including the plurality of pieces of apparatus information 164h1, the plurality of apparatus current direction diagrams 164k1, and the plurality of pieces of apparatus power information 164c1 (value of power) for each of the power generation apparatuses 70. The same applies to a case where a plurality of energy storage apparatuses 80 are connected to the charge-discharge system 10 and the apparatus selection information 41b is information indicating that the apparatus information 164h2 or the apparatus current direction diagram 164k2 displayed on the display device 41 has been selected.

When the plurality of power loads 20 are connected to the charge-discharge system 10, the acquisition unit 161 may be configured to be able to acquire information indicating that the load information 164d displayed on the display device 41 has been selected. In this case, the generation unit 162 can perform processing similar to the above. When the charge-discharge system 10 includes a plurality of power conditioners 100, the acquisition unit 161 may be configured to be able to acquire information indicating that information (such as area information 164e) indicating the power conditioner 100 displayed on the display device 41 has been selected. In this case, when the acquisition unit 161 has not acquired the information, the generation unit 162 may cause the display device 41 to display various pieces of information and diagrams by regarding the plurality of power conditioners 100 as one power conditioner. When the acquisition unit 161 has acquired the information, the generation unit 162 may cause the display device 41 to display various pieces of information and diagrams on each of the power conditioners 100.

As described above, the selection information acquisition processing (S108 in FIG. 6) performed by the generation unit 162 ends.

### [4 Description of Effects]

As described above, the charge-discharge system 10 according to the present embodiment generates the display data 164l for causing the display device 41 to display the screen including the area information 164e, the system information 164f, the vehicle energy storage apparatus information 164g, the system current direction diagram 164i, the vehicle current direction diagram 164j, and the load information 164d, and transmits the display data 164l to the display device 41. That is, the charge-discharge system 10 transmits, to the display device 41, the display data 164l of the screen including the information indicating the supply area 1, the power system 60, the vehicle energy storage apparatus 51, and the power load 20, and the diagram indicating the direction of the current of power between the power system 60 and the vehicle energy storage apparatus 51. With the diagram (system current direction diagram 164i) indicating the direction of the current of power between the charge-discharge system 10 and the power system 60, it is easy to intuitively grasp the exchange (purchase or sale) of the power between the charge-discharge system 10 and the power system 60. With the diagram (vehicle current direction diagram 164j) indicating the direction of the current of power between the charge-discharge system 10 and the vehicle energy storage apparatus 51, it is easy to intuitively grasp the exchange (charge or discharge) of power between the charge-discharge system 10 and the vehicle energy storage apparatus 51. Therefore, since the exchange of power between the charge-discharge system 10, and the power system 60 and the vehicle energy storage apparatus 51 in the target supply area 1 can be displayed in a diagram on the screen of the display device 41, the exchange of power in the charge-discharge system 10 can be easily grasped.

The charge-discharge system 10 generates, when determining that the power of at least one of the system power information 164a and the vehicle power information 164b is zero, the display data 164l for causing the display device 41 to display a screen including a diagram different from the case where the power is not zero or a screen not including the diagram. That is, the charge-discharge system 10 generates, when power is not exchanged with at least one of the power system 60 and the vehicle energy storage apparatus 51, the display data 164l for causing the display device 41 to display a screen indicating that power is not exchanged. If it is found that power is not exchanged between the charge-discharge system 10 and the power system 60, it can be grasped that the supply of power from the power system 60 to the charge-discharge system 10 is stopped due to a power failure or the like. If it is known that no power is exchanged between the charge-discharge system 10 and the vehicle energy storage apparatus 51, it can be grasped that charge-discharge is stopped between the charge-discharge system 10 and the vehicle energy storage apparatus 51 due to full charge of the vehicle energy storage apparatus 51, failure of equipment, or the like. Therefore, it is possible to cause the display device 41 to display a screen on which it can be intuitively grasped that the supply of power from the power system 60 to the charge-discharge system 10 is stopped or the charge-discharge between the charge-discharge system 10 and the vehicle energy storage apparatus 51 is stopped. As a result, the exchange of power in the charge-discharge system 10 can be easily grasped.

The charge-discharge system 10 generates the display data 164l for causing the display device 41 to display a screen on which the information and the diagram on the power system 60 are located above the area information 164e and the information and the diagram on the vehicle energy storage apparatus 51 and the power load 20 are located below the area information 164e. As a result, the information and the diagram of the power system 60 (the system information 164f and the system current direction diagram 164i) and the information and the diagram of the vehicle energy storage apparatus 51 and the power load 20 (vehicle energy storage apparatus information 164g, vehicle current direction diagram 164j, and load information 164d) can be divided and displayed at intuitively easy-to-understand positions on the screen of the display device 41. Therefore, the exchange of power in the charge-discharge system 10 can be easily grasped.

The charge-discharge system 10 generates, when determining that the vehicle energy storage apparatus 51 is not connected to the charge-discharge system 10, the display data 164l of a screen including vehicle energy storage apparatus information 164g different from the case of determining that the vehicle energy storage apparatus 51 is connected or a screen not including the information. That is, the charge-discharge system 10 generates, when the vehicle energy storage apparatus 51 is not connected to the charge-discharge system 10, the display data 164l for causing the display device 41 to display a screen indicating that the vehicle energy storage apparatus 51 is not connected. As a result, the connection state of the vehicle energy storage apparatus 51 to the charge-discharge system 10 can be displayed on the screen of the display device 41, so that it is easy to intuitively grasp that even if the charge discharge is stopped between the charge-discharge system 10 and the vehicle energy storage apparatus 51, it is not a failure of the equipment, and the like. Therefore, the exchange of power in the charge-discharge system 10 can be easily grasped.

The charge-discharge system 10 generates, when acquiring the vehicle selection information 41a, the display data 164l of a screen including the vehicle energy storage apparatus information 164g and the vehicle current direction diagram 164j for each of the vehicle energy storage apparatuses 51. As a result, when the plurality of vehicle energy storage apparatuses 51 are connected to the charge-discharge system 10, the information and the diagram for each of the vehicle energy storage apparatuses 51 can be displayed on the screen of the display device 41, so that it is easy to intuitively grasp the states of the plurality of vehicle energy storage apparatuses 51. Therefore, even when the plurality of vehicle energy storage apparatuses 51 are connected to the charge-discharge system 10, the exchange of power in the charge-discharge system 10 can be easily grasped for each of the vehicle energy storage apparatuses 51.

The charge-discharge system 10 generates the display data 164l for causing the display device 41 to display a screen further including apparatus information 164h and apparatus current direction diagram 164k. That is, the charge-discharge system 10 generates the display data 164l of a screen further including information indicating at least one of the power generation apparatus 70 and the energy storage apparatus 80 and the diagram indicating the direction of current of the power flowing between the at least one and the charge-discharge system 10. As a result, even when at least one of the power generation apparatus 70 and the energy storage apparatus 80 is connected to the charge-discharge system 10, the exchange of power between the charge-discharge system 10 and at least one of the power generation apparatus 70 and the energy storage apparatus 80 can be displayed in a diagram on the screen of the display device 41. Therefore, since it is easy to intuitively grasp the exchange of power between the charge-discharge system 10 and at least one of the power generation apparatus 70 and the energy storage apparatus 80, it is possible to easily grasp the exchange of power in the charge-discharge system 10.

The charge-discharge system 10 generates, when acquiring the apparatus selection information 41b, the display data 164l of a screen including the apparatus information 164h and the apparatus current direction diagram 164k for each of the power generation apparatuses 70 or the plurality of energy storage apparatuses 80. As a result, when the plurality of power generation apparatuses 70 or the plurality of energy storage apparatuses 80 are connected to the charge-discharge system 10, the information and the diagram for each of the power generation apparatuses 70 or the plurality of energy storage apparatuses 80 can be displayed on the screen of the display device 41. Therefore, even when the plurality of power generation apparatuses 70 or the plurality of energy storage apparatuses 80 are connected to the charge-discharge system 10, it is easy to intuitively grasp the states of the plurality of power generation apparatuses 70 or the plurality of energy storage apparatuses 80, so that it is possible to easily grasp the exchange of power in the charge-discharge system 10.

As described above, since the charge-discharge system 10 can cause the display device 41 to display a screen that is not too difficult and not too simple, it is possible to easily grasp the exchange of power in the charge-discharge system 10 with the display device 41. If the exchange of power in the charge-discharge system 10 can be easily grasped, the operation and the like of the vehicle 50 (business vehicle, commercial vehicle, or the like) can be intuitively understood and used for improvement, so that the energy management can be optimized.

For a public facility or a private facility considering introduction of the charge discharge system 10, it is not preferable that power reception from the power system 60 increases with system operation. By grasping the exchange of power in the charge discharge system 10 and efficiently receiving power from the power system 60, an increase in the electricity rate can be suppressed, and the introduction of the charge-discharge system 10 is promoted. It is also possible to contribute to enhancement of disaster prevention functions of public facilities, enhancement of BCP (business continuity plan during power failure) of private facilities, and the like.

Since it is possible to provide the charge-discharge system 10 that enables easily grasping the exchange of power, it contributes to the goal 7 “Ensure all people have access to inexpensive, reliable and sustainable modern energy” of the sustainable development goal (SDGs) led by the United Nations.

### [5 Description of Modification Example]

Although the charge-discharge system 10 and the like according to the present embodiment have been described above, the present invention is not limited to the above embodiment. The embodiment disclosed herein is illustrative in all respects and is not restrictive, and the scope of the present invention includes all modifications within the meaning and scope equivalent to the claims.

### First Modification Example

In the above embodiment, the display data 164l displayed on the display device 41 of the client device 40 may be displayed by animation. FIGS. 14A and 14B are diagrams illustrating an example of the display data 164l displayed on the display device 41 according to first modification example of the embodiment.

Among the arrow diagrams included in the display data 164l, the downward arrow diagram may be displayed by animation as illustrated in (a) to (e) of FIG. 14A. That is, the system current direction diagram 164i, the load information 164d2, the vehicle current direction diagram 164j (at the time of charging), and the apparatus current direction diagram 164k2 (at the time of charging) may be displayed by animation such that the diagram repeatedly changes at predetermined time intervals (one second or the like) in order from (a) to (e) of FIG. 14A.

Similarly, among the arrow diagrams included in the display data 164l, the upward arrow diagram may be displayed by animation as illustrated in (a) to (e) of FIG. 14B. That is, the vehicle current direction diagram 164j (at the time of discharging), the apparatus current direction diagram 164k1, and the apparatus current direction diagram 164k2 (at the time of discharging) may be displayed by animation such that the diagram repeatedly changes at predetermined time intervals (one second or the like) in order from (a) to (e) of FIG. 14B.

In FIGS. 14A and 14B, the diagram repeatedly changes in five steps, but may change in any number of steps, may change only for a certain period of time, and the time interval of the change is not particularly limited. As described above, the generation unit 162 generates the display data 164l including the above-described arrow diagram for animation display. The transmission unit 163 transmits the display data 164l generated by the generation unit 162 to the display device 41 of the client device 40.

### Second Modification Example

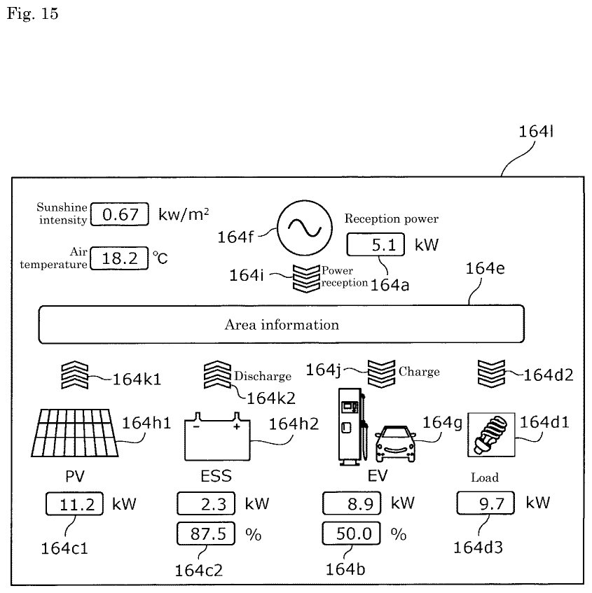

In the above embodiment, the display data 164l displayed on the display device 41 of the client device 40 may include items other than the above items. FIG. 15 is a diagram illustrating an example of display data 164l displayed on the display device 41 according to a second modification example of the embodiment.

In the present modification example, the system current direction diagram 164i also includes information (characters such as “power reception”, “power transmission”, or “power failure”) indicating the power reception state of the charge-discharge system 10 in addition to the diagram indicating the direction of the current, and the information indicating the power reception state is displayed next to the diagram indicating the direction of the current. Specifically, “power reception”, “power transmission”, or “power failure” is switched and displayed according to the power reception state of the charge discharge system 10. That is, when the direction of the arrow of the diagram is downward, the characters of “power reception” are displayed next to the diagram (see FIG. 15), and when the direction of the arrow of the diagram is upward, the characters of “power transmission” are displayed next to the diagram, and during the power failure, the characters of “power failure” are displayed.

Furthermore, the vehicle power information 164b also includes information indicating the remaining capacity of the vehicle energy storage apparatus 51 in addition to information indicating the power charged and discharged between the vehicle energy storage apparatus 51 and the charge-discharge system 10, and information indicating the remaining capacity is displayed below the information indicating the power. Specifically, the value (%) of the SOC of the vehicle energy storage apparatus 51 is displayed below the information indicating the power.

As described above, the display data 164l may include various items. The generation unit 162 generates the display data 164l including the various items. The transmission unit 163 transmits the display data 164l generated by the generation unit 162 to the display device 41 of the client device 40.

### OTHER MODIFICATION EXAMPLES

In the above embodiment, the second communication unit 230 may have the function of the first communication unit 160, or other devices in the charge discharge system 10 or devices outside the charge-discharge system 10 (the server device 30, the client device 40, or the like) may have the function.

In the above embodiment, the display data 164l may be displayed not on the display device 41 of the client device 40 but on a display device of the server device 30 or a display device of a device (the power conditioner 100 or the charge-discharge device 200) in the charge-discharge system 10.

In the above embodiment, both the power generation apparatus 70 and the energy storage apparatus 80 are connected to the charge-discharge system 10, but it is sufficient that at least one of the power generation apparatus 70 and the energy storage apparatus 80 is connected. Alternatively, neither the power generation apparatus 70 nor the energy storage apparatus 80 may be connected to the charge-discharge system 10.

In the above embodiment, the power conditioner 100 and charge-discharge device 200 of the charge-discharge system 10 may be integrated. The function of the charge-discharge device 200 may be incorporated in the power conditioner 100, or the function of the power conditioner 100 may be incorporated in the charge-discharge device 200.

In the above embodiment, the first communication unit 160 includes the storage unit 164, but may not include the storage unit 164, and may store information in an external recording medium and acquire information from the recording medium.

In the above embodiment, the generation unit 162 arranges the system information 164f, the system current direction diagram 164i, and the like above the area information 164e, and arranges the other information below the area information 164e. However, the information may be arranged upside down, or may be arranged separately on the left and right. In addition, the generation unit 162 may arrange various types of information and diagrams in any manner.

In the above embodiment, the system current direction diagram 164i is an arrow diagram indicating the direction of the current, but the direction of the current may be indicated by a diagram other than the arrow such as a triangle, a pentagon, a finger shape, or a convex shape. The system current direction diagram 164i may indicate the direction of the current by a color of the diagram or a character in the diagram instead of the shape of the diagram. The same applies to other diagrams indicating the directions of currents.

In the above embodiment, the order of various processing performed by the generation unit 162 may be changed. The processing of S202 and the processing of S204 in FIG. 7 may be interchanged, or the processing of S206 and the processing of S208 may be interchanged. The processing of S302 to S304 and the processing of S306 to S308 in FIG. 8 may be interchanged. The processing of S502 to S506 and the processing of S508 to S512 in FIG. 12 may be interchanged.

The present invention can be realized not only as the charge-discharge system 10 and the method for controlling the charge-discharge system 10 but also as a program for causing a computer to execute processing included in the method for controlling the charge-discharge system 10. That is, each component included in the first communication unit 160 of the charge-discharge system 10 may be realized by a program execution unit such as a CPU or a processor reading and executing a software program recorded in a recording medium such as a hard disk or a semiconductor memory. The present invention can also be realized as a computer-readable non-transitory recording medium in which the program is recorded, for example, a flexible disk, a hard disk, a CD-ROM, an MO, a DVD, a DVD-ROM, a DVD-RAM, a BD (Blu-ray (registered trademark) Disc), or a semiconductor memory. The program can be distributed via the recording medium and a transmission medium such as the Internet. The present invention can also be realized as an integrated circuit including a processing unit included in the charge-discharge system 10. That is, each functional block of the first communication unit 160 of the charge-discharge system 10 illustrated in FIG. 4 may be realized as a large scale integration (LSI) which is an integrated circuit. These may be individually integrated into one chip, or may be integrated into one chip so as to include a part or all of them. As described above, in the first communication unit 160 of the charge-discharge system 10, each component may be configured by dedicated hardware, or may be realized by executing a software program suitable for each component.

A mode constructed by combining arbitrary components in the above embodiment and its modification examples is also included in the scope of the present invention.

### INDUSTRIAL APPLICABILITY

The present invention can be applied to a charge-discharge system or the like that performs charge-discharge with an energy storage apparatus included in a vehicle.

### DESCRIPTION OF REFERENCE SIGNS

1: supply area
10: charge-discharge system
20: power load
30: server device
40: client device
41: display device
41a: vehicle selection information
41b: apparatus selection information
50: vehicle
51: vehicle energy storage apparatus
60: power system
70: power generation apparatus
80: energy storage apparatus
100: power conditioner
160: first communication unit
161: acquisition unit
162: generation unit
163: transmission unit
164: storage unit
164a: system power information
164b, 164b1, 164b2, 164b3: vehicle power information
164c, 164c1, 164c2: apparatus power information
164d, 164d1, 164d2, 164d3: load information
164e: area information
164f system information
164g, 164g1, 164g2, 164g3: vehicle energy storage apparatus information
164h, 164h1, 164h2: apparatus information
164i: system current direction diagram
164j, 164j1, 164j2, 164j3: vehicle current direction diagram
164k, 164k1, 164k2: apparatus current direction diagram
164l: display data
200: charge-discharge device
230: second communication unit

1. A charge-discharge system that performs charge-discharge with a vehicle energy storage apparatus that is an energy storage apparatus included in a vehicle in a predetermined supply area to which power from a power system is supplied, and supplies power to a power load in the supply area, the charge-discharge system comprising:
an acquisition unit that acquires system power information indicating power flowing between the power system and the charge-discharge system and vehicle power information indicating power charged and discharged between the vehicle energy storage apparatus and the charge-discharge system;
a generation unit that generates display data for causing a display device to display a screen including area information indicating the supply area, system information indicating the power system, vehicle energy storage apparatus information indicating the vehicle energy storage apparatus, a system current direction diagram that is a diagram indicating a direction of a current of power indicated by the system power information, a vehicle current direction diagram that is a diagram indicating a direction of a current of power indicated by the vehicle power information, and load information indicating a power consumption state of the power load; and
a transmission unit that transmits the display data to the display device.

2. The charge-discharge system according to claim 1, wherein
the generation unit
determines at least one of whether or not power indicated by the system power information is zero and whether or not power indicated by the vehicle power information is zero,
generates, when determining that power indicated by the system power information is zero, the display data for causing the display device to display a screen including the system current direction diagram different from a case where the power is not zero, or a screen not including the system current direction diagram; and
generates, when determining that power indicated by the vehicle power information is zero, the display data for causing the display device to display a screen including the vehicle current direction diagram different from a case where the power is not zero, or a screen not including the vehicle current direction diagram.

3. The charge-discharge system according to claim 1 or 2, wherein the generation unit generates the display data for causing the display device to display a screen on which the system information and the system current direction diagram are located above the area information, and the vehicle energy storage apparatus information, the vehicle current direction diagram, and the load information are located below the area information.

4. The charge-discharge system according to any one of claims 1 to 3, wherein the generation unit, when determining whether or not the vehicle energy storage apparatus is connected to the charge-discharge system and determining that the vehicle energy storage apparatus is not connected to the charge-discharge system, generates the display data for causing the display device to display a screen including the vehicle energy storage apparatus information different from a case where the generation unit determines that the vehicle energy storage apparatus is connected to the charge-discharge system, or a screen not including the vehicle energy storage apparatus information.

5. The charge-discharge system according to any one of claims 1 to 4, wherein
a plurality of the vehicle energy storage apparatuses are connected to the charge-discharge system,
the acquisition unit is configured to be able to acquire vehicle selection information indicating that the vehicle energy storage apparatus information or the vehicle current direction diagram displayed on the display device has been selected, and
the generation unit
generates, when the acquisition unit has not acquired the vehicle selection information, the display data for causing the display device to display a screen including the vehicle energy storage apparatus information and the vehicle current direction diagram by regarding the plurality of vehicle energy storage apparatuses as one vehicle energy storage apparatus, and
generates, when the acquisition unit has acquired the vehicle selection information, the display data for causing the display device to display a screen including the vehicle energy storage apparatus information and the vehicle current direction diagram for each of the vehicle energy storage apparatuses.

6. The charge-discharge system according to any one of claims 1 to 5, wherein
at least one of a power generation apparatus and an energy storage apparatus is connected to the charge-discharge system,
the acquisition unit acquires apparatus power information indicating power flowing between at least one of the power generation apparatus and the energy storage apparatus and the charge-discharge system, and
the generation unit generates the display data for causing the display device to display a screen further including apparatus information indicating at least one of the power generation apparatus and the energy storage apparatus and an apparatus current direction diagram which is a diagram indicating a direction of a current of power indicated by the apparatus power information.

7. The charge-discharge system according to claim 6, wherein
a plurality of the power generation apparatuses or a plurality of the energy storage apparatuses are connected to the charge-discharge system,
the acquisition unit is configured to be able to acquire apparatus selection information indicating that the apparatus information or the apparatus current direction diagram displayed on the display device has been selected, and
the generation unit
generates, when the acquisition unit has not acquired the apparatus selection information, the display data for causing the display device to display a screen including the apparatus information and the apparatus current direction diagram by regarding the plurality of power generation apparatuses or the plurality of energy storage apparatuses as one power generation apparatus or one energy storage apparatus, and
generates, when the acquisition unit has acquired the apparatus selection information, the display data for causing the display device to display a screen including the apparatus information and the apparatus current direction diagram for each of the power generation apparatuses or the energy storage apparatuses.

8. A method for controlling a charge-discharge system that performs charge-discharge with a vehicle energy storage apparatus that is an energy storage apparatus of a vehicle in a predetermined supply area to which power from a power system is supplied, and supplies power to a power load in the supply area, the method comprising:
acquiring system power information indicating power flowing between the power system and the charge-discharge system and vehicle power information indicating power charged and discharged between the vehicle energy storage apparatus and the charge-discharge system,
generating display data for causing a display device to display a screen including area information indicating the supply area, system information indicating the power system, vehicle energy storage apparatus information indicating the vehicle energy storage apparatus, a system current direction diagram that is a diagram indicating a direction of a current of power indicated by the system power information, a vehicle current direction diagram that is a diagram indicating a direction of a current of power indicated by the vehicle power information, and load information indicating a power consumption state of the power load; and
transmitting the display data to the display device.

9. A program for causing a computer to execute processing included in the method for controlling a charge-discharge system according to claim 8.
